(19) United States
(12) Patent Application Publication
(10) Pub. No.: US 2016/0191240 A1
(43) Pub. Date: Jun. 30, 2016

(54) ELECTRONIC DEVICE AND METHOD FOR ENCRYPTING AND DECRYPTING DATA

(71) Applicant: HON HAI PRECISION INDUSTRY CO., LTD., New Taipei (TW)

(72) Inventors: CHIH-YUAN CHUANG, New Taipei (TW); JUNG-YI LIN, New Taipei (TW); PO-JEN HSU, New Taipei (TW); CHIEN-MIN CHOU, New Taipei (TW); CHIH-TE LU, New Taipei (TW); SHU-YUAN CHANG, New Taipei (TW)

(21) Appl. No.: 14/847,446

(22) Filed: Sep. 8, 2015

(30) Foreign Application Priority Data
Dec. 31, 2014 (TW) 103146427

(51) Int. Cl. H04L 9/08

(52) U.S. Cl. CPC H04L 9/0825; H04L 9/0863

(57) ABSTRACT

A data encrypting and decrypting method which functions in an electronic device is activated when an application program is activated in the device. Data arising from user input is generated and a public and private key pair is also generated. The data is encrypted with the public key to obtain cryptographs and the cryptographs are sent to the application program. The method allows for decryption of the cryptographs with the private key to obtain the original data.

### CROSS-REFERENCE TO RELATED APPLICATIONS

This application claims priority to Taiwanese Patent Application No. 103146427 filed on Dec. 31, 2014, the contents of which are incorporated by reference herein.

### FIELD

The subject matter herein generally relates to data encryption and decryption.

### BACKGROUND

An electronic device can have a number of application programs installed. An input device of an electronic device can generate data in response to inputs of a user and send the data to an application program. However, the data can be hacked during transmission.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying an encrypting and decrypting system.

FIG. 2 is a diagrammatic view of a user interface displayed on the electronic device of FIG. 1.

FIG. 3 is a flowchart of a first embodiment of a data encrypting and decrypting method for an electronic device, such as the one of FIG. 1.

FIG. 4 is a flowchart of a second embodiment of a data encrypting and decrypting method for an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

The present disclosure is described in relation to an electronic device and data encrypting and decrypting method. Programs cause at least one processor to display at least one user interface of an application program which is activated. Input operations on the user interface are detected and data is thus generated. A key pair comprising a public key and an associated private key is generated and the data is encrypted with the public key to obtain cryptographs, the cryptographs being sent to the application program. The method can decrypt the cryptographs with the private key to obtain the original data.

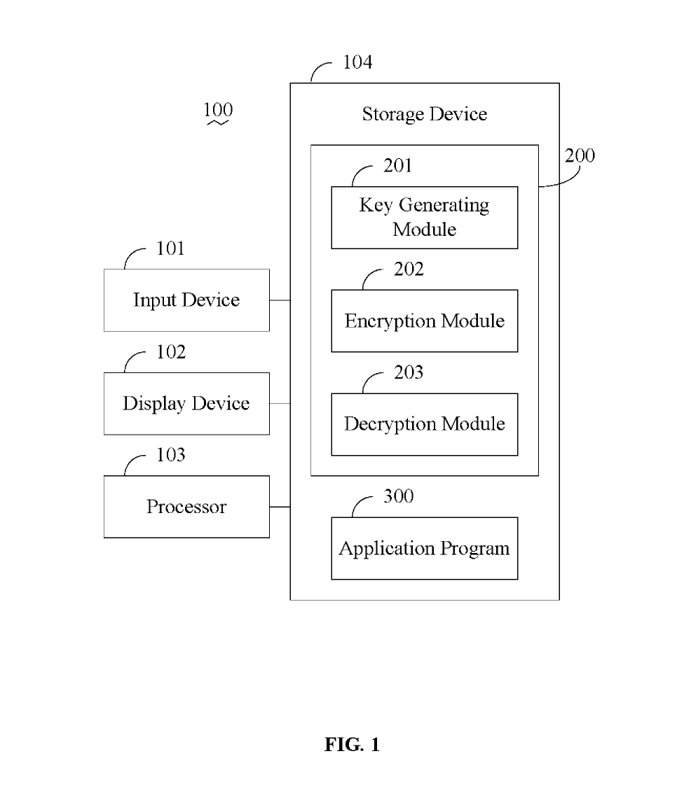

FIG. 1 illustrates an embodiment of an electronic device 100. An encrypting and decrypting system 200 is applied to the electronic device 100. The electronic device 100 can be a mobile phone or a tablet computer, or other portable device. The electronic device 100 can include an input device 101 and a display device 102. The electronic device 100 also can include at least one processor 103 and a storage device 104. In at least one embodiment, the electronic device 100 includes one processor 103. The processor 103 executes instructions of a number of modules stored in the storage device 104. The storage device 104 can store a key generating module 201, an encryption module 202 and a decryption module 203. The storage device 104 can also store at least one application program 300 installed in the electronic device 100.

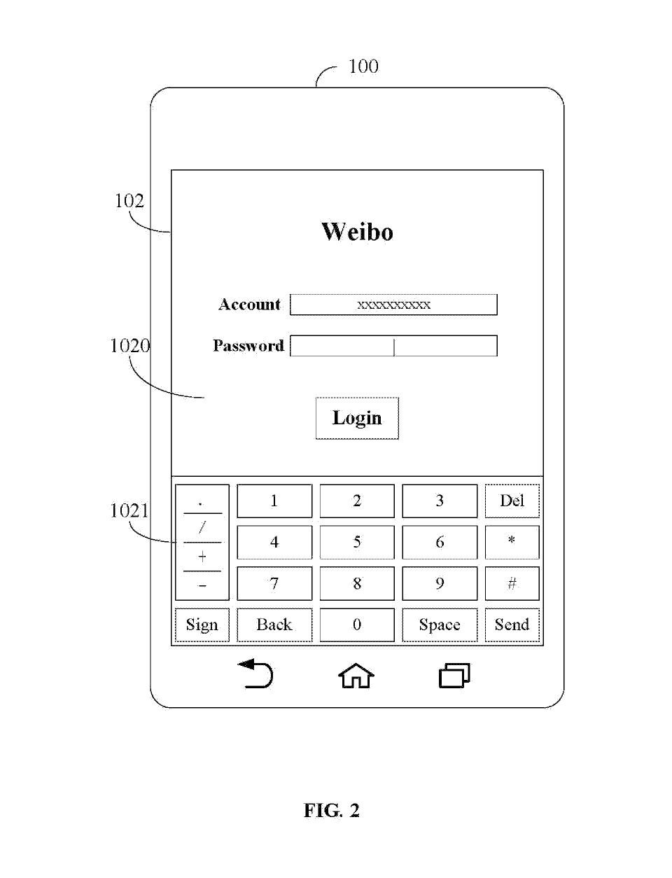

Referring to FIG. 2, the display device 102 can display a user interface 1020 when the application program 300 is activated. The display device 102 can also display a virtual keyboard 1021 on the user interface 1020 for user input. The input device 101 detects input operations on the user interface 1020 and generates corresponding data.

In a first embodiment, the key generating module 201 generates a public-private key pair when the application program 300 is installed. The public-private key pair includes a public key and a private key. The key generating module 201 sends the public key to the encryption module 202 and sends the private key to the decryption module 203. In at least one embodiment, the decryption module 203 is embedded in the application program 300.

The encryption module 202 encrypts the data, generated by the input device 101, with the public key to obtain cryptographs. The decryption module 203 can decrypt the cryptographs with the private key to obtain the original data. Then the application program 300 receives the data in clear and the display device 102 displays the data.

In a second embodiment, the key generating module 201 generates a first public-private key pair when the user interface 1020 is utilized by the user. The first public-private pair includes a first public key and a first private key. The key generating module 201 sends the first public key to the encryption module 202 and sends the first private key to the decryption module 203. In at least one embodiment, the decryption module 203 is embedded in the application program 300.

The encryption module 202 encrypts the data with the public key to obtain cryptographs. The decryption module 203 decrypts the cryptographs with the private key to obtain the data. Then the application program 300 receives the data from the decryption module 203 and the display device 102 displays the data. After the user input, such as the user closing the virtual keyboard 1021, the encryption module 202 abandons the first pubic key and the decryption module 203 abandons the private key. A second public-private pair is generated by the key generating module 201 when the user starts new input operations. The second public-private key pair includes a second public key and second private key. The key generating module 201 sends the second public key to the encryption module 202 to encrypt new data, and sends the second private key to the decryption module 203 to decrypt cryptographs corresponding to the new data.

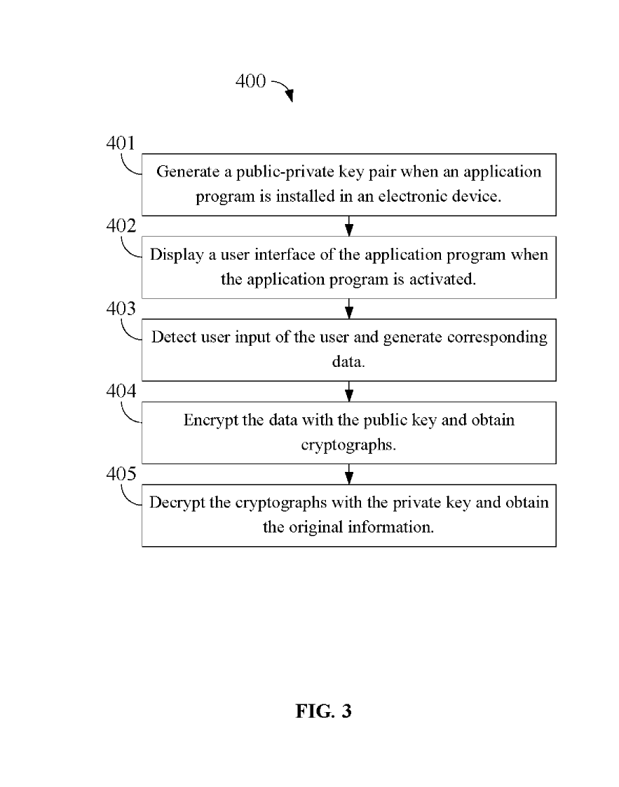

Referring to FIG. 3, a flowchart is presented in accordance with a first embodiment. A method 400 is provided by way of example, as there are varieties of ways to carry out the method. The method 400 described below can be carried out using the configurations illustrated in FIG. 1 and various elements of these figures are referenced in explaining example method 400. Each block shown in FIG. 3 represents one or more processes, methods, or subroutines, carried out in the exemplary method 400. Furthermore, the illustrated order of blocks is by example only and the order of the blocks can be changed. Additional blocks may be added or fewer blocks may be utilized, without departing from this disclosure. The exemplary method 400 can begin at block 401.

At block 401, a key generating module generates a public-private key pair when an application program is installed in an electronic device. The public-private key pair includes a public key and private key. Then the key generating module sends the public key to an encryption module and sends the private key to a decryption module. In at least one embodiment, the decryption module is embedded in the application program.

At block 402, a display device displays a user interface of the application program when the application program is activated. In at least one embodiment, the display device further displays a virtual keyboard on the user interface.

At block 403, an input device detects user input and generates corresponding data.

At block 404, the encryption module encrypts the data, generated by the input device, with the public key to obtain cryptographs, and sends the cryptographs to the application program.

At block 405, the decryption module decrypts the cryptographs with the private key to obtain the data. Then the application program can receive the data from the decryption module and display the data.

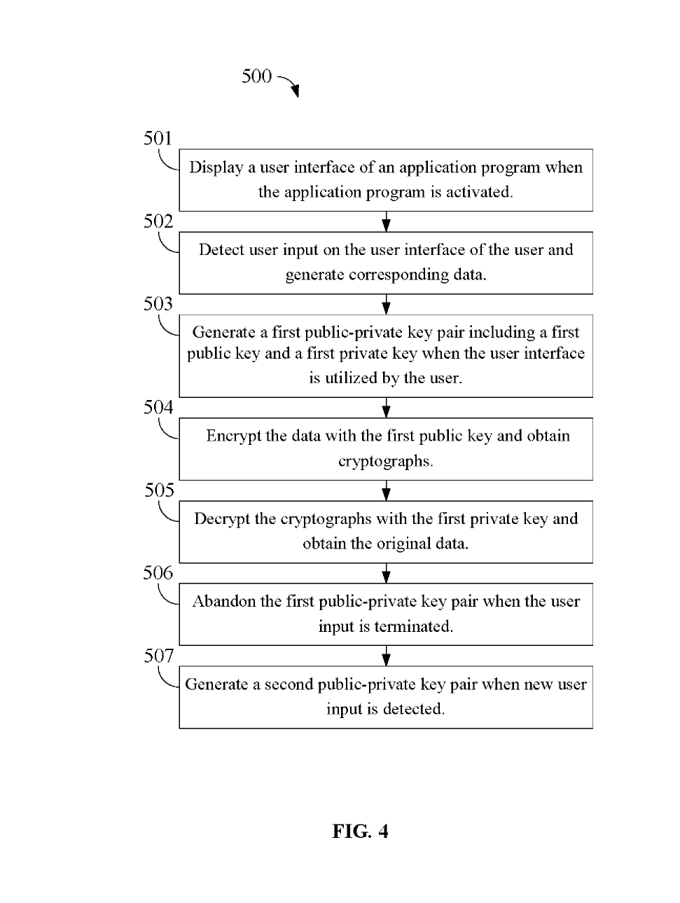

Referring to FIG. 4, a flowchart is presented in accordance with a second embodiment. A method 500 is provided by way of example, as there are a variety of ways to carry out the method. The method 500 described below can be carried out using the configurations illustrated in FIG. 1 and various elements of these figures are referenced in explaining example method 500. Each block shown in FIG. 4 represents one or more processes, methods, or subroutines, carried out in the exemplary method 500. Furthermore, the illustrated order of blocks is by example only and the order of the blocks can be changed. Additional blocks may be added or fewer blocks may be utilized, without departing from this disclosure. The exemplary method 500 can begin at block 501.

At block 501, a display device displays a user interface corresponding to an application program when the application program is activated. In at least one embodiment, the display device further displays a virtual keyboard on the user interface for a user to input.

At block 502, an input device detects user input and generates corresponding data.

At block 503, a key generating module generates a first public-private key pair when the user gives input. The first public-private key pair includes a first public key and a first private key. Then the key generating module sends the first public key to an encryption module and sends the first private key to a decryption module. In at least one embodiment, the decryption module is embedded in the application program.

At block 504, the encryption module encrypts the data, generated by the input device, with the first public key to obtain cryptographs. The encryption module further sends the cryptographs to the application program.

At block 505, the decryption module decrypts the cryptographs with the first private key to obtain the original data. Then the application program receives the data from the decryption module and the display device displays the data.

At block 506, the encryption module abandons the first public key and the decryption module abandons the first private key when user input is terminated. In at least one embodiment, if the user taps a “close” symbol on the user interface to close the virtual keyboard, then the input is determined to be finished.

At block 507, the key generating module generates a second public-private key pair when the user starts new input. The second public-private key pair includes a second public key and a second private key. Then the key generating module sends the second public key to the encryption module to encrypt data corresponding to the new input operations, and sends the second private key to the decryption module to decrypt cryptographs corresponding to the new data.

The embodiments shown and described above are only examples. Many details are often found in the art such as the other features of an electronic device and method for encrypting and decrypting data. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An electronic device comprising:
a display device configured to display at least one user interface of an application program;
an input device configured to detect user input on the user interface and generate corresponding data;
at least one processor;
a non-transitory storage device coupled to the at least one processor and storing one or more programs, which when executed by the at least one processor, cause the at least one processor to:
generate a key pair comprising a public key and an associated private key;
encrypt the data with the public key to obtain cryptographs;
send the cryptographs to the application program; and
decrypt the cryptographs with the private key to obtain the original data.

2. The electronic device of claim 1, wherein the one or more programs cause the at least one processor to further: generate the key pair when the application program is installed in the electronic device.

3. The electronic device of claim 1, wherein the one or more programs cause the at least one processor to further: generate the key pair when the user interface is utilized by the user.

4. The electronic device of claim 3, wherein the one or more programs cause the at least one processor to further:
abandon the key pair if the user input is terminated; and
generate a new key pair if new user input is detected.

5. The electronic device of claim 4, wherein the user interface comprises a virtual keyboard, if the user taps the user interface to close the virtual keyboard, the user input is determined to be finished.

6. A computer-based method for encrypting and decrypting data for an electronic device being executed by at least one processor of the electronic device, the method comprising:
displaying at least one user interface of an application program;
detecting user input on the user interface and generating corresponding data;
generating a key pair comprising a public key and an associated private key;
encrypting the data with the public key to obtain cryptographs;
sending the cryptographs to the application program; and
decrypting the cryptographs with the private key to obtain the original data.

7. The method of claim 6, wherein the method comprising: generating the key pair when the application program is installed in the electronic device.

8. The method of claim 6, wherein the method comprising: generating the key pair when the user interface is utilized by the user.

9. The method of claim 8, wherein the method further comprising:
abandoning the key pair if the user input is terminated; and
generating a new key pair if new user input is detected.

10. The method of claim 9, wherein the user interface comprises a virtual keyboard, if the user taps the user interface to close the virtual keyboard, the user input is determined to be finished.

11. A non-transitory storage device having stored thereon code that, when executed by an electronic device, causes the electronic device to perform a data encrypting and decrypting method, the code comprising:
code for displaying at least one user interface of an application program;
code for detecting user input on the user interface and generating corresponding data;
code for generating a key pair comprising a public key and an associated private key;
code for encrypting the data with the public key to obtain cryptographs;
code for sending the cryptographs to the application program; and
code for decrypting the cryptographs with the private key to obtain the original data.

12. The method of claim 11, wherein the method comprising: generating the key pair when the application program is installed in the electronic device.

13. The method of claim 11, wherein the method comprising: generating the key pair when the user interface is utilized by the user.

14. The method of claim 13, wherein the method further comprising:
abandoning the key pair if the user input is terminated; and
generating a new key pair if new user input is detected.

15. The method of claim 14, wherein the user interface comprises a virtual keyboard, if the user taps the user interface to close the virtual keyboard, the user input is determined to be finished.
